(19) United States
(12) Patent Application Publication
(10) Pub. No.: US 2011/0109081 A1
(43) Pub. Date: May 12, 2011

(54) Drilling riser connector

(76) Inventor: Benton Frederick Baugh, Houston, TX (US)

(21) Appl. No.: 12/590,510

(22) Filed: Nov. 10, 2009

(51) Int. Cl. F16L 23/00; F16L 25/00

(52) U.S. Cl. 285/148.28; 285/420

(57) ABSTRACT

The method of providing a clamping connection comprising providing one or more clamping hubs, providing two or more clamping segments to engage the clamping hubs, constraining the clamping segments to move approximately radially with respect to the clamp hubs, providing a tension band around the clamping segments which slides circumferentially relative to the clamping segments, and adjusting the ratio of the contact area of the tension band to the clamping hubs and the area of the clamping hubs to compensate for the difference in loading on the clamping hub due to sliding friction between the tension band and the clamping hubs.

### TECHNICAL FIELD

This invention relates to the general subject of connecting sections of riser pipe for drilling oil or gas wells in deep water.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The field of this invention is that drilling risers for deep water blowout preventer systems are major pieces of capital equipment landed on the ocean floor in order to provide a conduit for the drill pipe and drilling mud while also providing pressure protection while drilling holes deep into the earth for the production of oil and gas. The typical blowout preventer stacks have an 18¾ inch bore and are usually of 10,000 psi working pressure. The blowout preventer stack assembly weighs in the range of five hundred to eight hundred thousand pounds. It is typically divided into a lower blowout preventer stack and a lower marine riser package.

The lower blowout preventer stack includes a connector for connecting to the wellhead at the bottom on the seafloor and contains several individual ram type blowout preventer assemblies, which will close on various pipe sizes and in some cases, will close on an open hole with what are called blind rams. Characteristically there is an annular preventer at the top, which will close on any pipe size or close on the open hole.

The lower marine riser package typically includes a connector at its base for connecting to the top of the lower blowout preventer stack, it contains a single annular preventer for closing off on any piece of pipe or the open hole, a flex joint, and a connection to a riser pipe which extends to the drilling vessel at the surface.

The purpose of the separation between the lower blowout preventer stack and the lower marine riser package is that the annular blowout preventer on the lower marine riser package is the preferred and most often used pressure control assembly. When it is used and either has a failure or is worn out, it can be released and retrieved to the surface for servicing while the lower blowout preventer stack maintains pressure competency at the wellhead on the ocean floor.

The riser pipe extending to the surface is typically a 21 inch O.D. pipe with a bore larger than the bore of the blowout preventer stack. It is a low pressure pipe and will control the mud flow which is coming from the well up to the rig floor, but will not contain the 10,000-15,000 psi that the blowout preventer stack will contain. Whenever high pressures must be communicated back to the surface for well control procedures, smaller pipes on the outside of the drilling riser, called the choke line and the kill line, provide this function. These will typically have the same working pressure as the blowout preventer stack and rather than have an 18¾-20 inch bore, they will have a 3-4 inch bore. There may be additional lines outside the primary pipe for delivering hydraulic fluid for control of the blowout preventer stack or boosting the flow of drilling mud back up through the drilling riser.

### BRIEF SUMMARY OF THE INVENTION

The object of this invention is to provide a connector for the drilling riser which can be made up by the operation of a single bolt.

A second object of this invention is to provide a multi-section clamp with relatively uniform make-up around the perimeter of the connection.

### BRIEF DESCRIPTION OF THE DRAWINGS

FIG. 1 is a view of a deepwater drilling system using the drilling riser connection of this invention

FIG. 2 is a more detailed view of the riser and blowout preventer stack as seen in FIG. 1

FIG. 3 is a view of a portion of a conventional drilling riser using a conventional connection.

FIG. 4 shows a perspective view of a pair of conventional buoyancy modules.

FIG. 5 is a view of a portion of a drilling riser utilizing the connection of this invention.

FIG. 6 is a half section of the flotation being installed on a riser joint.

FIG. 7 is a half section of a riser joint with all the flotation loaded.

FIG. 8 is a half section showing an outside fluid line being installed.

FIG. 9 is a half section of a section of drilling riser using the connection of this invention.

FIG. 10 is a half section through lines “10-10” of FIG. 14.

FIG. 11 is an end view of a conventional clamp.

FIG. 12 is a half section taken along lines “12-12” of FIG. 11.

FIG. 13 is an end view of a conventional clamp similar to view 11, but being partially made up.

FIG. 14 is a half section of a clamp of this invention taken along lines “14-14” of FIG. 10.

FIG. 15 is an end view of a clamp of this drilling riser showing the test lines.

FIG. 16 is a graph illustrating the typical pressure decline of a freshly pressured line.

### DETAILED DESCRIPTION OF THE INVENTION

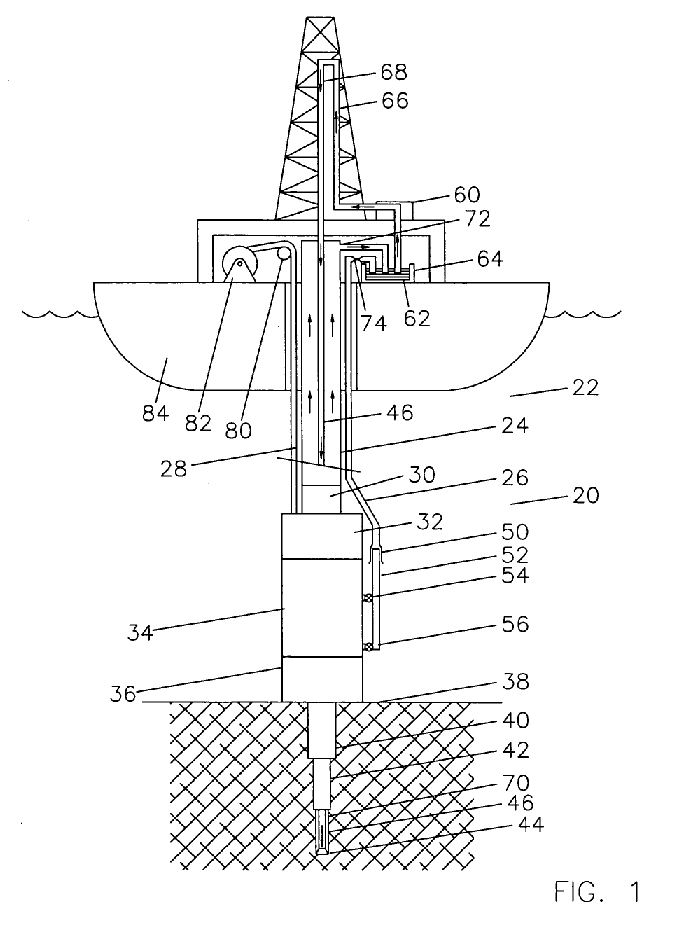

Referring now to FIG. 1, a view of a complete system for drilling subsea wells 20 is shown in order to illustrate the utility of the present invention. The drilling riser 22 is shown with a central pipe 24, outside fluid lines 26, and control lines 28.

Below the drilling riser 22 is a flex joint 30, lower marine riser package 32, lower blowout preventer stack 34 and wellhead 36 landed on the seafloor 38.

Below the wellhead 36, it can be seen that a hole was drilled for a first casing string, that string 40 was landed and cemented in place, a hole drilled thru the first string for a second string, the second string 42 cemented in place, and a hole is being drilled for a third casing string by drill bit 44 on drill string 46.

The lower Blowout Preventer stack 22 generally comprises a lower hydraulic connector for connecting to the subsea wellhead system 36, usually 4 or 5 ram style Blowout Preventers, an annular preventer, and an upper mandrel for connection by the connector on the lower marine riser package 32.

Below outside fluid line 26 is a choke and kill (C&K) connector 50 and a pipe 52 which is generally illustrative of a choke or kill line. Pipe 52 goes down to valves 54 and 56 which provide flow to or from the central bore of the blowout preventer stack as may be appropriate from time to time. Typically a kill line will enter the bore of the Blowout Preventers below the lowest ram and has the general function of pumping heavy fluid to the well to overburden the pressure in the bore or to “kill” the pressure. The general implication of this is that the heavier mud will not be circulated, but rather forced into the formations. A choke line will typically enter the well bore above the lowest ram and is generally intended to allow circulation to circulate heavier mud into the well to regain pressure control of the well.

Normal drilling circulation is the mud pumps 60 taking drilling mud 62 from tank 64. The drilling mud will be pumped up a standpipe 66 and down the upper end 68 of the drill pipe 46. It will be pumped down the drill pipe 46, out the drill bit 44, and return up the annular area 70 between the outside of the drill pipe 21 and the bore of the hole being drilled, up the bore of the casing 42, through the subsea wellhead system 36, the lower blowout preventer stack 34, the lower marine riser package 32, up the drilling riser 24, out a bell nipple 72 and back into the mud tank 64.

During situations in which an abnormally high pressure from the formation has entered the well bore, the thin walled drilling riser 24 is typically not able to withstand the pressures involved. Rather than making the wall thickness of the relatively large bore drilling riser thick enough to withstand the pressure, the flow is diverted to a choke line 26. It is more economic to have a relatively thick wall in a small pipe to withstand the higher pressures than to have the proportionately thick wall in the larger riser pipe.

When higher pressures are to be contained, one of the annular or ram Blowout Preventers are closed around the drill pipe and the flow coming up the annular area around the drill pipe is diverted out through choke valve 54 into the pipe 52. The flow passes up through C&K connector 50, up pipe 26 which is attached to the outer diameter of the riser 24, through choking means illustrated at 74, and back into the mud tanks 64.

On the opposite side of the drilling riser 24 is shown a cable or hose 28 coming across a sheave 80 from a reel 82 on the vessel 84. The cable 28 is shown characteristically entering the top of the lower marine riser package. These cables typically carry hydraulic, electrical, multiplex electrical, or fiber optic signals. Typically there are at least two of these systems, which are characteristically painted yellow and blue. As the cables or hoses 28 enter the top of the lower marine riser package 32, they typically enter the top of control pod to deliver their supply or signals. When hydraulic supply is delivered, a series of accumulators are located on the lower marine riser package 32 or the lower Blowout Preventer stack 34 to store hydraulic fluid under pressure until needed.

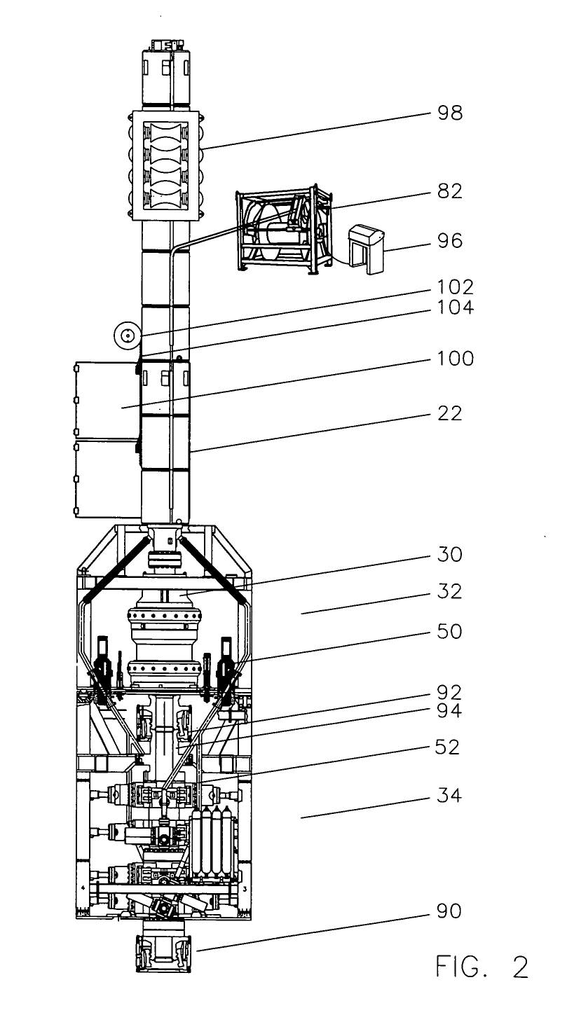

Referring now to FIG. 2, a portion of the complete system for drilling subsea wells 20 is shown in greater detail for better clarity. Connector 90 at the bottom is hydraulically operated to provide a connection between the lower blowout preventer stack 34 and the subsea wellhead system 36 as shown in FIG. 1. Hydraulic connector 92 provides a connection between the lower marine riser package 32 and mandrel 94 on the lower blowout preventer stack 34.

Control panel 96 is shown to control the reel 82. Centralizer 98 would be used to control the position of the riser as it is being pulled in currents to prevent it from be pushed into the side of the rotary table by the currents. Fairings 100 can be used to provide a better flow profile and reduce the drag forces on the riser. Winch 102 and chain 104 indicate that the fairings are of a “run through” type which means they are independently supported from the drilling rig, can be run after the riser is in the water, and can remain in place when most of the riser is retrieved, rather than the style which are fixed to individual riser joints.

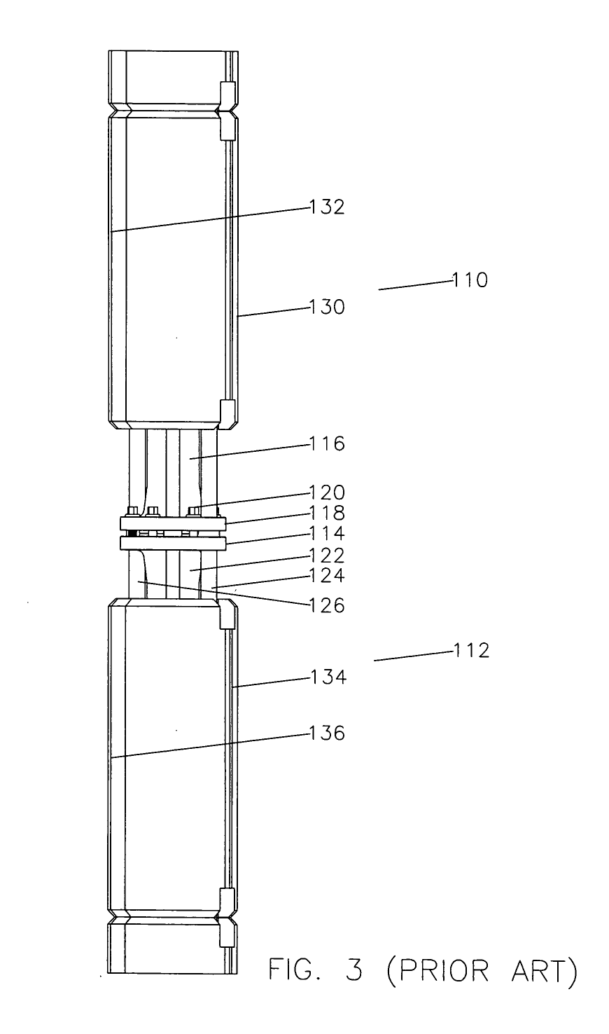

Referring now to FIG. 3, the connection of two sections of conventional drilling riser 110 is seen. On the upper end of a conventional riser joint 112 an upper flange 114 is seen. It is connected to the flange on the lower end of the adjacent conventional riser joint 116 by lower flange 118 and a multiplicity of bolts 120. The pipe 122 between the upper flange 114 and the lower flange 118 on the same riser joint is typically of a 21″ outer diameter, with a varying wall thickness depending primarily on water depth and the resulting tensile loadings. All risers typically will have a choke line 124 and a kill line 126 as outside fluid lines, and may also have hydraulic supply lines and mud flow boost lines. Each of these lines are the typical 70 ft. in length as is the effective length of the conventional drilling riser.

Buoyancy module sections 130 and 132 are shown attached to the lower end of the conventional riser joint 116 and buoyancy modules 134 and 136 are shown attached to the upper end of conventional riser joint 112. The conventional riser joints are 70 ft. long and the flotation modules are conventionally 129″ long. Six sections of the 129″ long flotation are attached to each riser joint, leaving a gap of 60″ or 5 feet in the area of the connection. The space on the upper end of conventional riser joint 112 is used for the insertion of support dogs when running the riser. The larger space on the bottom of the adjacent riser joint 116 is used for the insertion of a hydraulic make-up wrench when running the riser. It is conventional to use 6 support dogs, giving 6 spaces for bolts between the outside fluid lines.

When the drilling riser sees side currents and rollers need to contact the riser assembly to keep it centralized as it is pulled, these long gaps at the connections can be a significant problem. This problem has been addressed in a separate patent application for the Thunderhorse PDQ drilling rig by adding a rotating track, which in one position provides a necessary track for roller and at another rotational orientation provides access to the support shoulders and access for insertion of the wrenches.

Referring now to FIG. 4, the profile 140 inside the buoyancy half circle module sections is shown. There are bands 142 and 144 molded inside the modules which provide for a known contact with the pipe when the steel pipe is flexed one way or the other way. There are three notches 146, 148, and 150 which allow the flotation modules to be installed onto the assembly when the outside fluid lines are in place. There are notches 152 and 154 which allow the control lines 28 to be stored and clamped in place. There are recesses 156 on each end to allow for clamps which restrain the outside fluid lines 26, and secure the axial position of the buoyancy modules such that they do not block the wrench space or the space for the support dogs.

The weak points in these modules are a load on the center back, causing a tensile failure at 158 and a cantilever or diving board type failure at 159.

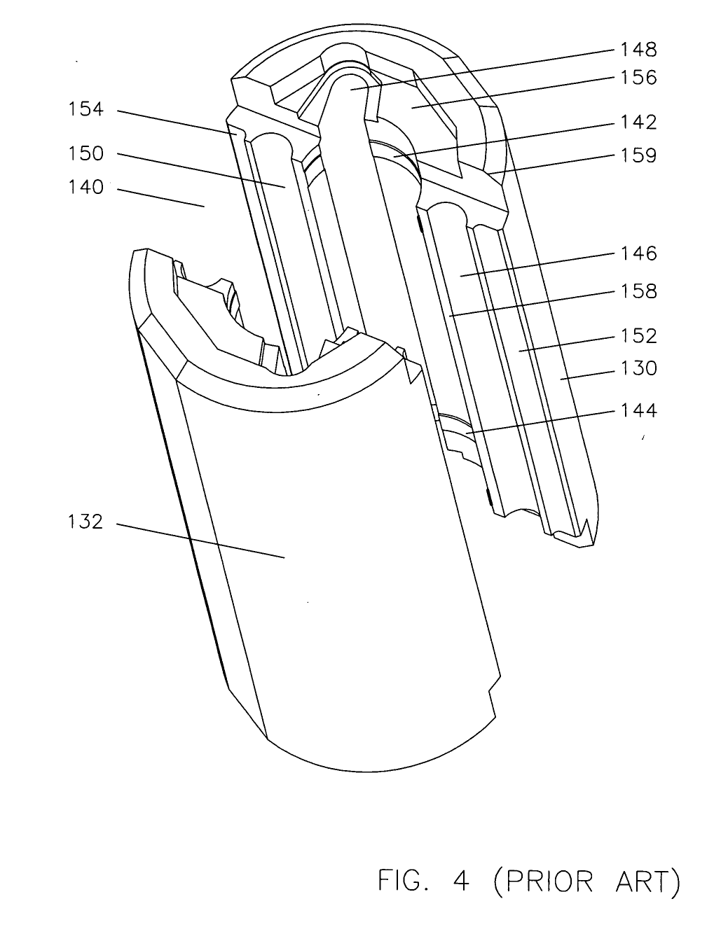

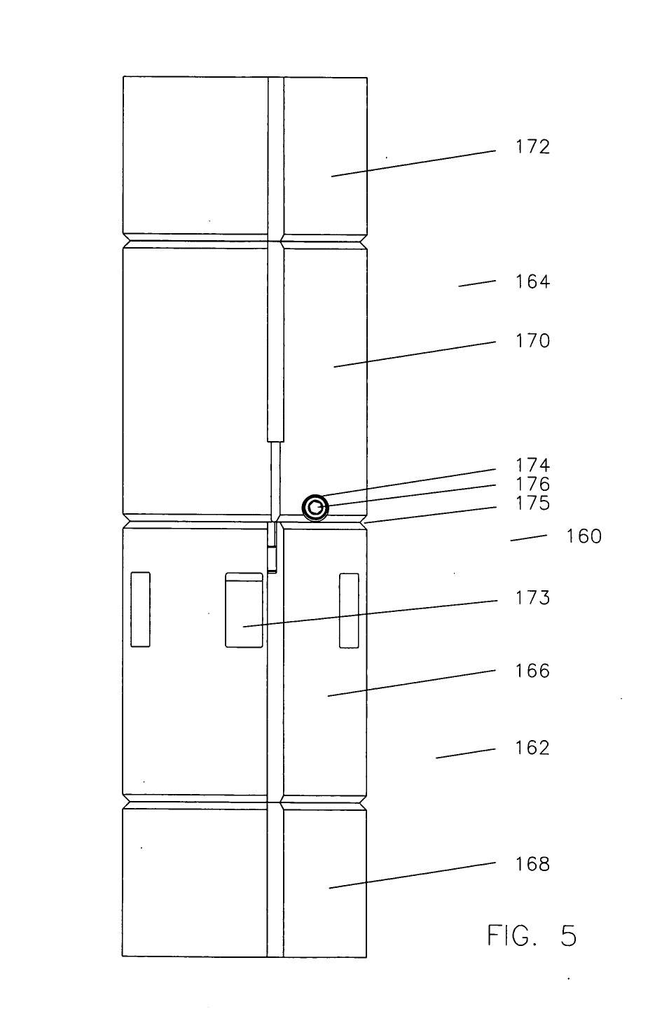

Referring now to FIG. 5, a similar section of riser 160 of the present invention is shown as was shown in FIG. 3 comprising of a lower riser section 162 and an upper riser section 164. As can be appreciated, when the riser is lowered 70 ft. during the running operations, the upper riser section 164 becomes lower riser section 162 and a fresh riser section becomes upper riser section 164. Lower riser section 162 has buoyancy modules 166 and 168. Upper riser section 164 has buoyancy modules 170 and 172.

All buoyancy module sections 166-172 are a one piece full circle instead of half circle as shown in FIG. 4, but approximately one half as long as the half sections on the conventional drilling riser.

Buoyancy module 166 is specific for the top location of the riser with slots or windows 173 for the insertion of support dogs. The slots or windows 173 (and dogs to be inserted) are tall and narrow rather than flat to minimize circumferential space required for the dog support. This change will allow adequate roller contact in this area without having to have rotatable tracks.

Buoyancy module 164 is specific for the bottom location on each riser joint as hole 174 allows access to a single bolt 176 to make up a novel connection as discussed hereinafter. The nature of these two modules reduces the gap at the connection between the riser joints from 5 feet to a small chamfer 175 the size of the chamfer on all other flotation modules.

Buoyancy modules 168 and 172 are identical and are identical of all intermediate buoyancy modules on the riser joint. Construction of the modules as full circles of one half the length substantially increases the strength of the modules against roller loading failure. Full circle is much stronger than half circle, and half length is much stronger than double length due to shorter bending moment.

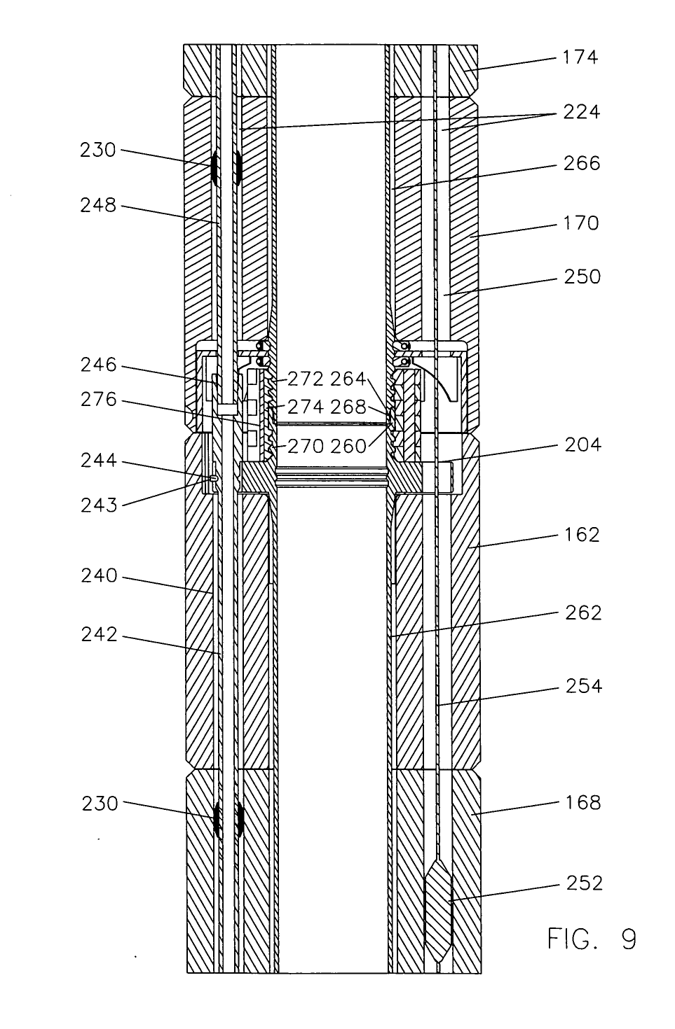

Referring now to FIG. 6, a riser joint 200 is shown with the flotation being installed. Central pipe 202 is shown with an upper flange 204, but no lower flange. Two loading stands 206 and 208 are shown. Circular flotation modules 210 and 212 are shown slipped over the lower end 214 of the riser joint 200 which has no flange. At this time the lower end 214 will be picked up and the buoyancy modules 210 and 212 will be slid down to buoyancy module 216 and tab 218 will engage socket 220 to provide a known orientation between adjacent buoyancy modules. This will be continued until all buoyancy modules are installed and a lower support flange is bolted in place. If will be described in greater detail in FIG. 9.

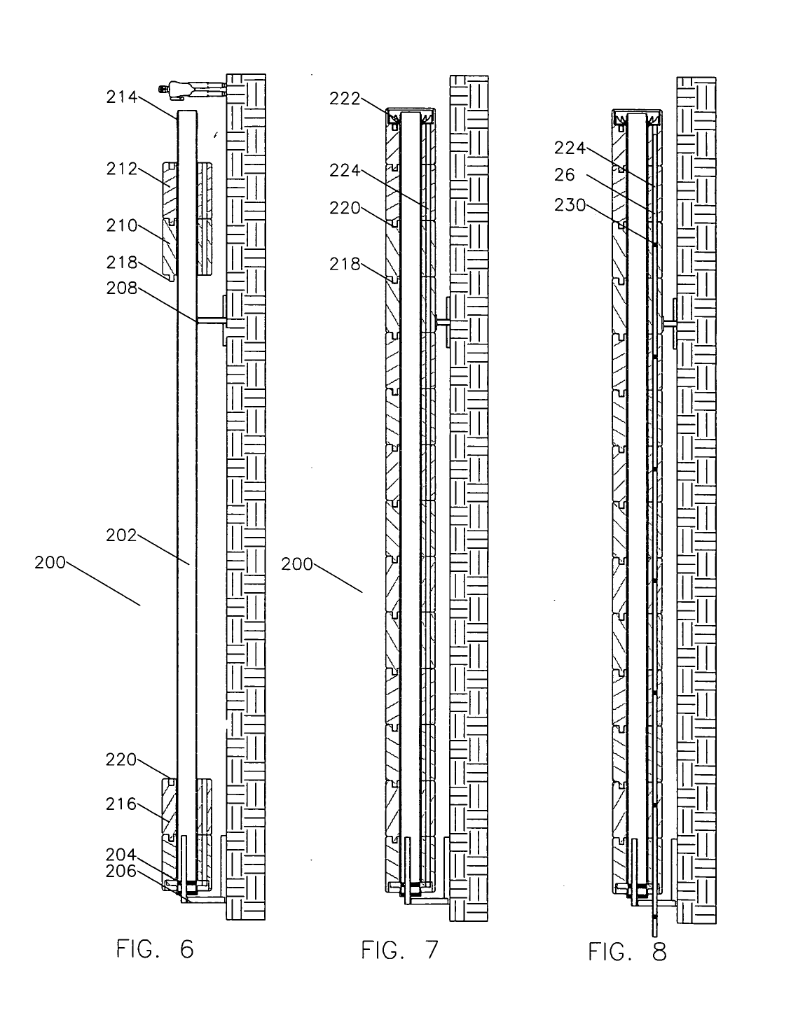

Referring now to FIG. 7, the riser joint 200 is completely outfitted with buoyancy modules and a lower support flange 222. A complete passageway 224 is shown from the upper end of the riser joint to the lower joint. Passageway 224 represents 5 passageways at 60 degree spacing, with the sixth position having the tabs 218, sockets 220, and bolting as will be seen.

Referring now to FIG. 8, an outside fluid line 26 such as a choke or kill line is being slid into one of the passageways 224. Stabilizing centralizers 230 are, installed onto the outside fluid line 26 to stabilize it within the passageways 224, eliminating the conventional requirement for special clamps which are required to restrain the outside fluid lines.

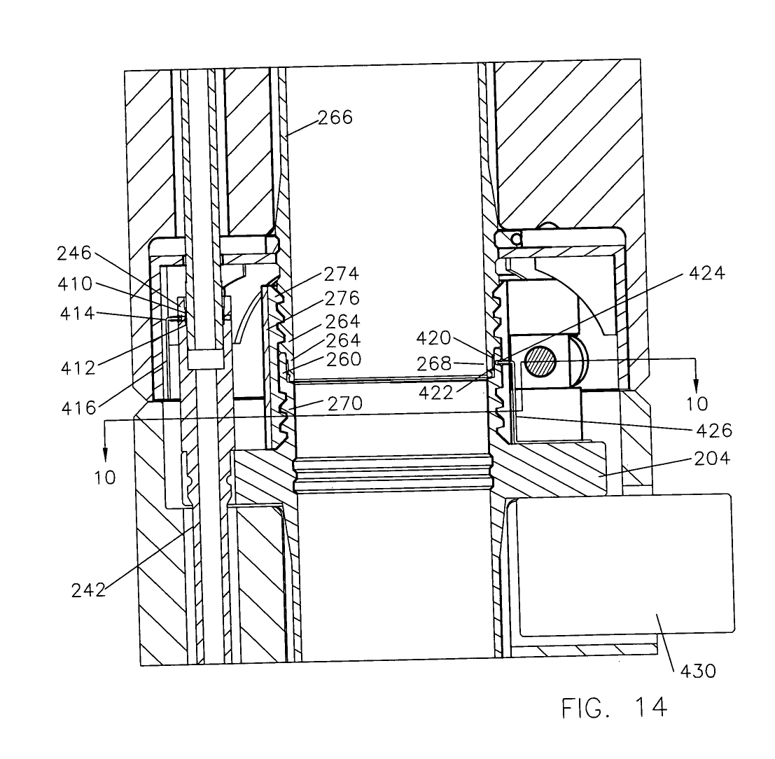

Referring now to FIG. 9, a half section is shown of the riser joint of FIG. 5 thru two of the passageways 224. Passageway 240 has outside fluid line 242 installed with a retaining pin 243 installed into a hole in the side of flange 204 to engage groove 244 to fix the outside fluid line 242 in place. Stabilizing centralizers 230 are shown to stabilize fluid line 242 within passageway 240. Seals 246 seal outside fluid line 242 to outside fluid line 248 as will be discussed in more detail in FIG. 14.

Passageway 250 has not received an outside fluid line, but rather is shown as providing a passageway for other services. These services can be to lower instrumentation 252 on a wire 254 such as is shown to measure vortex induced vibration in a riser. Alternately passageway 250 can provide a passageway all the way to the bottom like the vacuum tubes used in banks. A hose can be lowered down to deliver hydraulic fluid. A control connector can be lowered on a control line to provide backup control for a blowout preventer stack in case of controls difficulties. A “Go-Devil” on simple weight can be dropped to actuate a single function in an emergency situation. Basically passageway 250 becomes a utility passageway for anything which needs to be done along or at the bottom of the riser.

A receptacle 260 (See also FIG. 14) at the upper end of lower riser pipe 262 is engaged by nose 264 on the lower end of upper riser pipe 266. Seals 268 seal between receptacle 260 and nose 264. The upper end of lower riser pipe 262 has a clamping profile 270 and the lower end of upper riser pipe 266 has a clamping profile 272. Clamp segments 274 engage the clamping profiles 270 and 272. Tension band 276 urges clamp segments 274 into engagement with clamping profiles 270 and 272 to secure the connection.

Referring now to FIG. 10, the clamp segments 274 as shown in FIG. 9 are shown here to be four clamping segments of differing length 280, 282, 284, and 286. Each segment is constrained to move radially into contract with the clamping profiles 270 and 272 as shown in FIG. 9 by keyways 290, 292, 294, and 296, respectively.

The tension band 276 is shown to be made of four section 300, 302, 304, and 306. They are hinged together by hinge pins 310, 312, and 314. At the fourth connection a double pin arrangement is used. A threaded pin 320 is engaged by bolt 322. A non-threaded pin 324 is engaged by shoulder 326 on bolt 322.

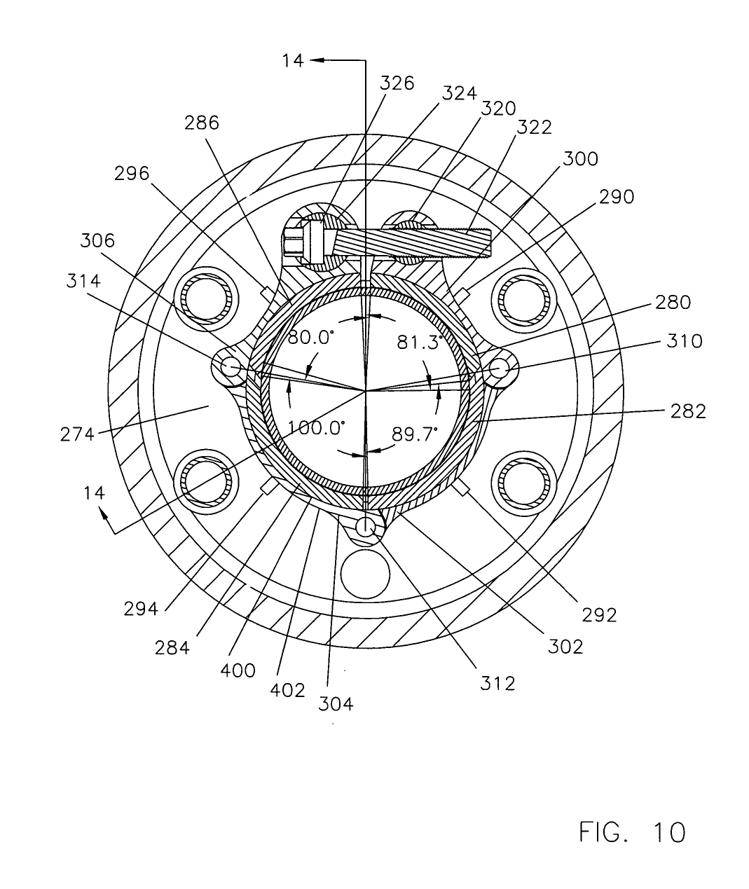

Referring now to the prior art of FIG. 11, the advantage for the novel design shown in FIG. 10 becomes apparent to those of skill in the art. A two section clamp 350 has clamp halves 352 and 354 tightened on clamp hubs 356 by bolts 358. The inner diameter 360 is Intended to be pulled to be concentric with diameter 362 of the clamp hubs 356.

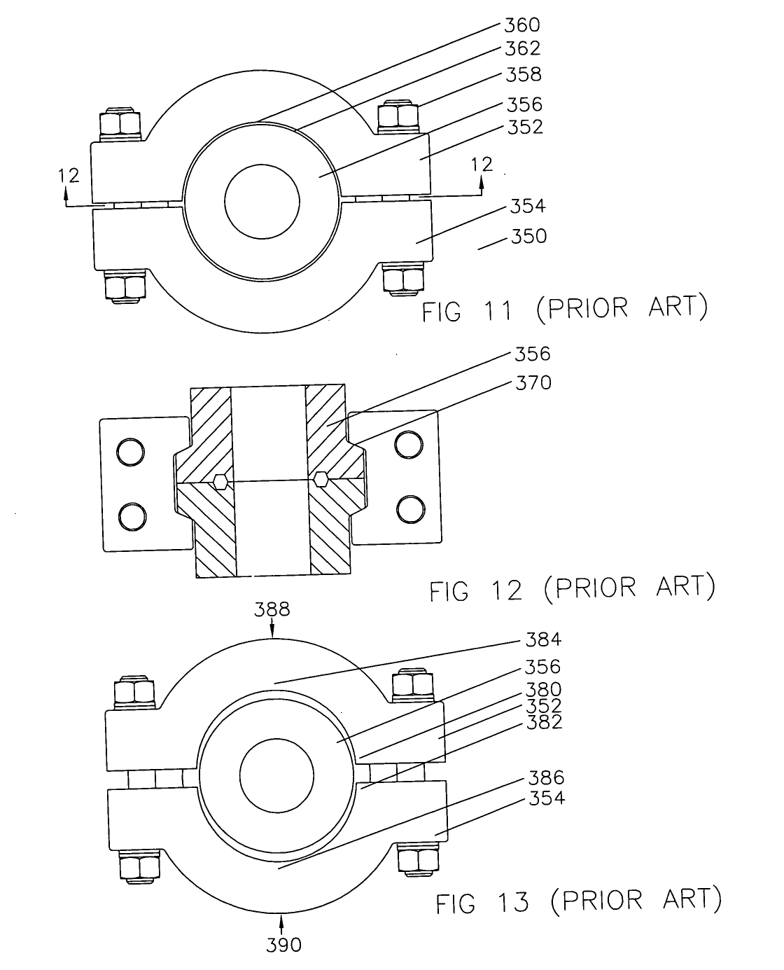

Referring now to FIG. 12, the engagement of the clamp halves is shown to be on a taper 370 which has approximately a 25 degree slope. It is literally a wedge moving onto the clamp hubs.

Referring now to FIG. 13, a view similar to FIG. 11 is shown, but with the clamps about ¼″ from full make-up. Clamp sections 352 and 354 are actually touching clamp hubs 356 only at areas 380 and 382 respectively. Literally no contact is made at areas 384 and 386. The situation is that of a wedge being drug sideways onto the clamp hubs. The result of this type make-up is that the loading in the general areas of 380 and 382 will be high and the loading at 384 and 386 will be low. In some cases the clamp sections of this type are struck with a sledge hammer at locations 388 and 390 to jar the clamp sections into a position of more uniform loading around the circumference.

The irregularity of this make-up can be tolerated on small clamps and clamps which have relatively low loading. On high load clamps such as on deepwater drilling risers, this irregularity of make-up is simply not acceptable.

Referring again to FIG. 10, make-up onto the tapered clamp hubs 270 and 272 of FIG. 9 is constrained to be done radially rather than sliding around the wedge surface. The outer surface 400 of the clamping segments 280, 282, 284, and 286 is a simple cylindrical surface. Outer surface 400 is engaged by simple cylindrical surface 402 of tension band sections 300, 302, 304, and 306. As the tension band is pulled to a smaller diameter by bolt 322, the tension band segments 300, 302, 304, and 306 slide circumferentially around the clamping segments 280, 282, 284, and 284. The load on the clamping segments 282 and 284 will be less than the load on the clamping segments 280 and 286 by the friction on the back of clamping segments 280 and 286. If the coefficient of friction is 0.15, the unit loadings on the clamp segments will be reduced by 15%, rather than the high loses seen by the wedging action of a conventional clamp.

To compensate for this difference in unit loadings, the ratio of the loading area to the ratio of clamping area has been adjusted. In this case the loading area is shown on the left side of the figure and is divided to 80 degrees and 100 degrees. The clamping area is shown on the right hand side of the drawing and is divided to 81.3 degrees and 89.7 degrees. This works out to (100/80)*(81.3/89.7)=1.13 if the sliding area were frictionless. If the coefficient friction was 0.13, the mechanical size changes would closely compensate for this difference. This means that the loads around circumference would be approximately equal rather from varying from high to potentially zero in conventional clamps.

Referring now to FIG. 14, double seals 246 on outside fluid line 242 are shown as seals 410 and 412 with a test port 414 located between seals 410 and 412 and test pressure connecting lines 416. Each of the outside fluid lines will have similar seals, test ports and test pressure connecting lines. Seals 268 on upper riser pipe 266 are shown as seals 420 and 422 with a test port 424 located between seals 420 and 422 and a test pressure connecting line 426.

Flange 204 is shown being supported by dogs 430 which are extended from a riser spider (not shown).

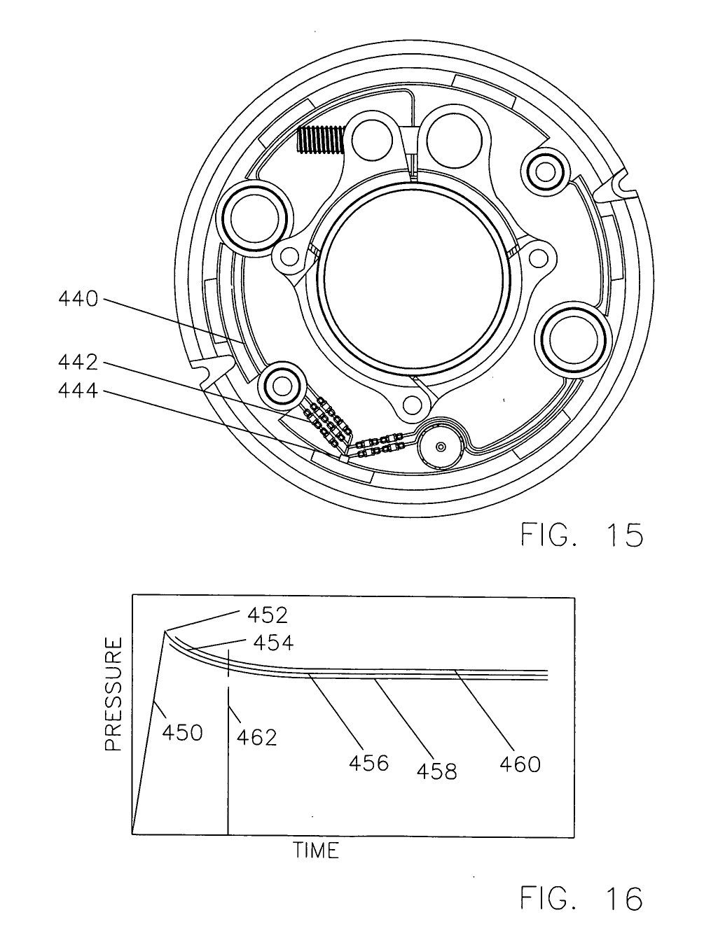

Referring now to FIG. 15, test pressure lines 440 come from each of the test ports on each of the outside fluid lines and the central pipe connections. Each of the lines go to double check valves 442 and are in turn directed to fitting 444. In this way when a test pressure device is attached to fitting 444, all of the hydraulic lines can be quickly tested to the maximum pressure which can be withstood by any of the lines. As a small area will be exposed to pressure, a higher pressure can be delivered to the test port than the lowest pressure pipe can withstand, likely twice as high as unpressured areas next to the seal area will tend to reinforce the test area. Test pressure fitting 444 does not have a check valve in it such that pressure in any of the test lines 440 is solely sealed by a pair of check valves at 444. If the check valves at 444 fail for any reason, the resultant leak will not be able to enter another set of check valves and back pressure any of the other fittings, but rather simply goes into the sea water.

As make-up of the connection is now controlled by a single bolt, empirical studies can be done to determine the relationship of torque and turn of a properly made up connection. The relationship of torque and turn can be input into a computer and measured each time a connection is made. When this is measured, it can be quickly compared to historical connections and determined if it is a proper make-up. If the make-up curve is too flat, it will likely mean that the connection is failing. If the make-up curve is too steep, it likely means that the bolt is galling. Rather than the 15 minutes required to make up a conventional 6 bolt connection, the single bolt make-up can be likely done within 1 minute and will have a computer generated confirmation of the quality of the make-up.

During the 1 minute to make-up the connection, another employee can attach a test pressure device to the fitting 444 and do a 1 minute test on the various seals. In the one minute, the pressure in the test ports will not stabilize due to temperature cooling. However, they will decline in a predictable fashion and a computer will be able to predict that the seals have quality sealing. If desired, the employee can wait 3 to 5 minutes for confirmation that the pressure is stable, or has gone “flatline”.

Referring now to FIG. 16, a pressure time graph is shown. Line 450 indicates that the pressure is being rapidly increased from zero to a maximum amount quickly. At point 452 a valve is shut off to block the supply. The liquid and some air in the lines have been quickly pressurized and therefore heated some. As the heat dissipates into the surrounding steel, the pressure drops some until it stabilizes or goes “flatline”. Line 454 is what a typical pressure curve looks like as it goes “flatline”. At point 456 on this curve it has gone “flatline” after a period of time, i.e. 3 minutes. Lines 458 and 460 show the limits of what the pressure curve is likely to look like during successful testing. It will have some limited variation based on how much liquid is in the lines and how much air is in the lines. Line 462 shows a time during this period, i.e. 1 minute after pressurizing. If curve 458 and 460 have been determined by real life experience and at time 462 the curve is within the limits, there is a high degree of assurance that the test will be a successful test. If this data is fed into a computer, at time 462 the computer can determine that it is likely to be a successful test and indicate that operations can continue. The indication can be by a variety of means such as a printed report or a green light for GO and a red light for STOP.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. The method of providing a clamping connection comprising
providing one or more clamping hubs,
providing two or more clamping segments to engage said clamping hubs,
constraining said clamping segments to move approximately radially with respect to said clamp hubs,
providing a tension band around said clamping segments which slides circumferentially relative to said clamping segments, and
adjusting the ratio of the contact area of said tension band to said clamping segments and the contact area of said clamping segments to said clamping hubs to compensate for a difference in loading on said clamping hubs due to sliding friction between said tension band and said clamping hubs.

2. The method of claim 1 further comprising said clamping connection is on a subsea drilling riser.

3. The method of claim 1 further comprising said tension band comprises a multiplicity of tension segments.

4. The method of claim 3 further comprising said loading on said clamping hubs due to a particular clamping segment is directly proportionate to a circumferential length of said particular clamping segment.

5. The method of claim 3 further comprising said loading on said clamping hubs from said clamping segments is inversely proportionate to the contact area between said clamping hubs and said clamping segments.

6. The method of claim 1 further comprising providing a plurality of ridges in said contact area of said two or more damping segments to said one or more clamping hubs.

7. The method of claim 1 further comprising selectively coating at least one of said tension band and said two or more clamping segments to provide a selected coefficient of friction in said contact area of said tension band to said two or more clamping segments.

8. The method of claim 7 wherein said coefficient of friction is in a range between 0.085 and 0.20.

9. The method of claim 1 further comprising providing that said tension band is tightened by rotating a single threaded member.

10. The method of claim 1 further comprising providing that an amount of variation in loading around said one or more clamping hubs is less than 10% of a maximum radially directed load applied to said one or more clamping hubs.

11. A clamping connection which secures two ends of pipes together, comprising:
clamping hubs disposed on said two ends of said pipes;
at least two clamping segments positioned circumferentially to said clamping hubs, said at least two clamping segments each comprising interior rounded surfaces that engage said clamping hubs around a circumference of said clamping hubs, said at least two clamping segments having different circumferential lengths;
a tension band which encircles said clamping segments;
an adjustment member which rotates to tighten said tension band to thereby urge said plurality of clamping segments radially inwardly toward said clamping hubs.

12. The clamping connection of claim 11, wherein said tension band further comprises at least two tension segments, and at least one pivotal connection between said at least two tension segments.

13. The clamping connection of claim 11, further comprising constraining structures that limit rotational movement of said at least two clamping segments with respect to said clamping hubs while permitting radial movement of said at least two clamping segments with respect to said clamping hubs;

14. The clamping connection of claim 11, wherein said adjustment member consists of a single threaded member.

15. The clamping connection of claim 11, wherein said different circumferential lengths are selected to produce a selected range of variation in load applied around a circumference of said clamping hubs.

16. A clamping connection which secures two ends of pipes together, comprising:
clamping hubs disposed on said two ends of said pipes;
at least two clamping segments which comprise interior rounded surfaces that engage said clamping hubs around a circumference of said clamping hubs;
constraining structures that limit rotational movement of said at least two clamping segments with respect to said clamping hubs while permitting radial movement of said at least two clamping segments with respect to said clamping hubs;
a tension band which encircles said at least two clamping segments; and
an adjustment member to tighten said tension band to thereby urge said at least two clamping segments radially inwardly toward said clamping hubs around said circumference of said clamping hubs.

17. The clamping connection of claim 16, wherein said adjustment member consists of a single rotatable threaded member.

18. The clamping connection of claim 16, wherein said rounded interior surfaces of said at least two clamping segments comprise different circumferential lengths.

19. The clamping connection of claim 18, wherein said different circumferential lengths are selected to produce a selected range of variation in load applied around said circumference of said clamping hubs.

20. The clamping connection of claim 16 wherein said tension band comprises at least two tension segments and at least one pivotal connection between said at least two tension segments.

21. The clamping connection of claim 16 wherein said clamping hubs define a nose and a mating receptacle.

22. A method of providing a clamping connection between ends of pipes, comprising
providing one or more clamping hubs;
providing two or more circumferential clamping segments to engage a circumference of said one cr more clamping hubs;
providing a tension band around said clamping segments which slides circumferentially relative to said clamping segments to urge said two or more circumferential clamping segments into engagement with said circumference of said one or more clamping hubs, and
providing that differences in circumferential lengths of said two or more circumferential clamping segments are selected to limit load variations around said circumference of said one or more clamping hubs applied by said two or more circumferential clamping segments.

22. The method of claim 21 further comprising providing that said variation in load is less than 10% of a maximum load applied around said circumference of said clamping hubs.

23. The method of claim 21 further comprising providing that said variation in said load applied by said two or more circumferential clamping segments on said circumference of said clamping hubs results from frictional forces between said tension band and two or more circumferential clamping segments, and further providing that said differences in circumferential lengths of said two or more circumferential clamping segments is selected to offset said frictional forces.
